(19) United States
(12) Patent Application Publication
(10) Pub. No.: US 2023/0401615 A1
(43) Pub. Date: Dec. 14, 2023

(54) OPTIMIZATION SYSTEM AND OPTIMIZATION METHOD

(71) Applicant: HITACHI, LTD., Tokyo (JP)

(72) Inventors: Kenichiro YAMADA, Tokyo (JP); Yoshiki YUMBE, Tokyo (JP); May TAKADA, Tokyo (JP); Ippei NUMATA, Tokyo (JP); Tasuku SOGA, Tokyo (JP)

(21) Appl. No.: 18/033,755

(22) PCT Filed: Sep. 2, 2021
(86) PCT No.: PCT/JP2021/032223

§ 371 Date: Apr. 25, 2023

(30) Foreign Application Priority Data
Nov. 13, 2020 (JP) 2020-189082

(51) Int. Cl. G06Q 30/06; G06Q 20/20; G06V 10/44; G06V 10/764

(52) U.S. Cl. CPC G06Q 30/06; G06Q 20/20; G06V 10/44; G06V 10/764

(57) ABSTRACT

An optimization system includes: a customer touring acquisition unit that is configured to be able to acquire touring of stores by a customer; a store attribute information acquisition unit that is configured to be able to acquire one or more items of store attribute information for classifying features of the stores; a model training unit that creates a correlation model for the touring by the customer and the store attribute information by using the touring of the stores by the customer and the store attribute information as inputs; and a trained model storage unit that stores the created model, in which information regarding one or more stores to be opened is presented in such a way as to increase the touring of the stores by the customer based on the model.

### CROSS-REFERENCE TO RELATED APPLICATIONS

This application is US National Stage of International Patent Application PCT/JP2021/032223, filed Sep. 2, 2021, which claims benefit of priority from Japanese Patent Application JP2020-189082, filed Nov. 13, 2020, the contents of both of which are incorporated herein by reference.

### TECHNICAL FIELD

The present invention relates to an optimization system and an optimization method for a store tenant combination.

### BACKGROUND ART

A technology for analyzing data acquired by a sensor or image data captured by a camera and utilizing the data in retail and distribution industries has been widely utilized in business along with the development of AI technologies, the data being collected and accumulated as so-called big data. For example, PTL 1 describes that “a space is modeled using images from a set of cameras in the space. An easy to use tool is provided that allows users to identify a reference location in an image and a corresponding reference location on a floor plan of the space. Based on these correspondences, a model is generated that can map a point in a camera's view to a point on the floor plan, or vice-versa”. Meanwhile, PTL 2 describes that “a method of promoting an action of a user by using a computer, the method comprising: a presentation step of mechanically extracting an option from a pool including a plurality of options related to the action and presenting the option to the user; and a creation step of creating an option sheet including the option selected by the user from among the options presented in the presentation step”.

### CITATION LIST

### Patent Literature

PTL 1: U.S. Ser. No. 10/163,031
PTL 2: JP 2020-149723 A

### SUMMARY OF INVENTION

### Technical Problem

A real estate developer operating a so-called shopping mall makes money from rents of tenants occupying the shopping mall. In general, the rent is often the amount of money obtained by multiplying a sales amount of a tenant by a certain ratio, and it is a major problem for the real estate developer to promote shopping in the shopping mall and increase touring in order to increase the sales amount of the tenant and to expand a purchase opportunity of a visitor.

According to the invention described in PTL 1, there is known a technology of performing shopper traffic line analysis with high accuracy by using integrated data obtained by virtually connecting map information of the entire selling area and image data of a plurality of cameras having different visual fields. However, the purpose of PTL 1 is only to analyze a series of actions from an entrance to a cash register in a certain store with high accuracy, and does not include measures for increasing touring of a plurality of tenants or increasing the sales based on the acquired traffic line data, which is a problem of a real estate developer.

In addition, according to the invention described in PTL 2, in a stamp rally organized for sales promotion among a plurality of stores, a preference of a visitor is estimated based on a purchase history of the visitor, and a candidate (store) group of the stamp rally that matches the preference is proposed in order to promote shopping by the visitor. However, as a measure for increasing touring, it is not realistic to perform only the stamp rally regularly, not for a limited period, in view of sustainability of a customer attraction effect. In this regard, an object of the present invention is to provide an optimization system and an optimization method for a store tenant combination in order to steadily increase touring of tenants or sales, which is an improvement goal of a real estate manager who operates a shopping mall.

### Solution to Problem

The above problem is solved by, for example, the invention described in the claims.

### Advantageous Effects of Invention

According to the embodiment described below, it is possible to implement a continuous increase in touring or sales by store tenant combination optimization.

### BRIEF DESCRIPTION OF DRAWINGS

FIG. 1 is a schematic diagram illustrating an overall image of an optimization system 200 for a store tenant combination according to a first embodiment.

FIG. 2 is a functional block diagram of the optimization system 200 for a store tenant combination according to the first embodiment.

FIG. 3 is a sequence diagram illustrating a data flow in the first embodiment.

FIG. 4 is a flowchart illustrating touring data creation processing in the first embodiment.

FIG. 5 is a flowchart illustrating tenant attribute creation processing.

FIG. 6 is a flowchart illustrating processing of creating a correlation model for touring and a tenant attribute in the first embodiment.

FIG. 7 illustrates an example of a tenant attribute DB 215.

FIG. 8 is a flowchart illustrating an optimal tenant selection simulation using the correlation model.

FIG. 9 illustrates an example of a user interface 900 in the optimal tenant selection simulation.

FIG. 10 illustrates a rough classification of optimal tenant selection simulation conditions.

FIG. 11 illustrates an example of a pop-up store tenant in which portable furniture 1100 is installed.

FIG. 12 is a schematic diagram illustrating an overall image of an optimization system 200 for a store tenant combination according to a second embodiment.

FIG. 13 is a functional block diagram of the optimization system 200 for a store tenant combination according to the second embodiment.

FIG. 14 is a flowchart illustrating processing of creating a correlation model for sales and a tenant attribute in the second embodiment.

### DESCRIPTION OF EMBODIMENTS

Hereinafter, embodiments of the present invention will be described with reference to the drawings.

### First Embodiment

An embodiment of the present invention will be described with reference to the accompanying drawings. The present embodiment is an embodiment for describing an optimization system for a new store tenant combination for continuously increasing touring of permanent tenants in real estate such as a shopping mall.

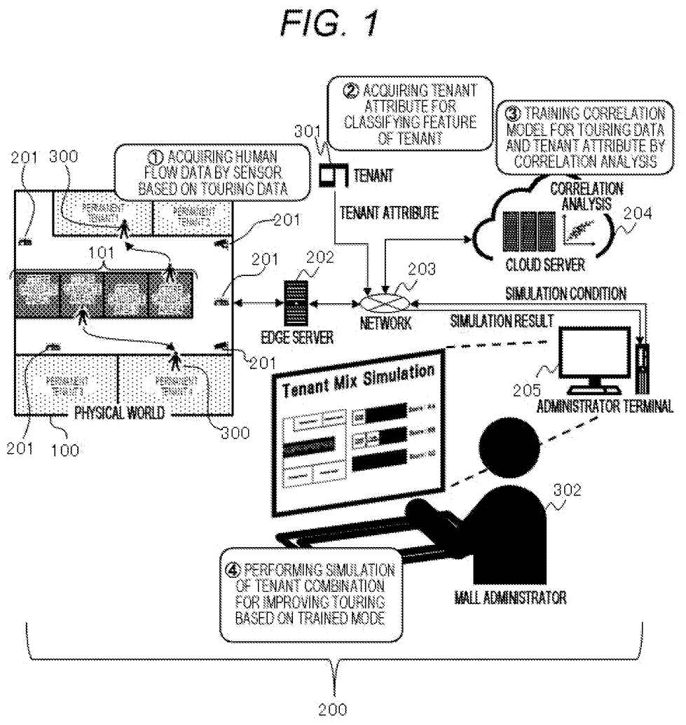

FIG. 1 is a schematic diagram illustrating an overall image of an optimization system 200 for a store tenant combination according to the present embodiment. The optimization system 200 in the present embodiment roughly has four characteristics. The first characteristic is that a sensor acquires human flow data that is a basis of touring data. Human flow data of a shopper 300 in a mall in a physical world 100 is acquired by a sensor group 201 and used as base data for store touring data. The second characteristic is that a tenant attribute for classifying a feature of a tenant is acquired. The third characteristic is that a correlation model for the touring data and the tenant attribute is trained by correlation analysis. The correlation model to be used in a simulation to be described later is created by training using the touring data and the tenant attribute as inputs. The last fourth characteristic is that a new tenant combination for maximizing touring of permanent tenants is simulated based on the trained model. A mall administrator 302 can smoothly make a tenant's store opening plan necessary for achieving a continuous increasing in touring of tenants in a shopping mall managed by the mall administrator 302, by using the optimization system 200.

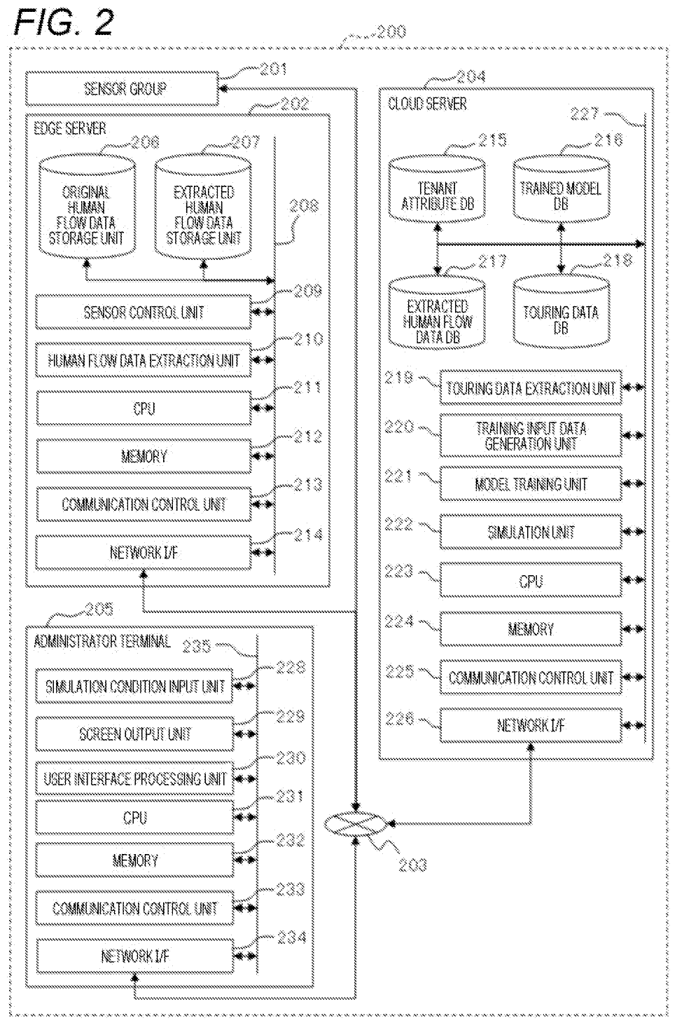

FIG. 2 is a functional block diagram of the optimization system 200 for a store tenant combination according to the present embodiment. The optimization system 200 for a store tenant combination includes the sensor group 201, an edge server 202, a network 203, a cloud server 204, and an administrator terminal 205. In FIG. 2, the optimization system 200 is expressed as a cloud service of the cloud server 204 and the administrator terminal 205 as a client via the network 203, but the optimization system 200 is not limited to the cloud service, and may be an on-premises service in which the functions of the cloud server 204 and the administrator terminal 205 are included in the edge server 202.

The sensor group 201 includes one or more sensors installed in a store area of a tenant in a shopping mall or the like and can detect a human flow. Examples of the sensor include a two-dimensional or three-dimensional range sensor using a time of flight (ToF) method, but is not necessarily limited to the range sensor, and may be an imaging device that captures a moving image, such as an analog camera or an IP camera as long as original human flow data can be extracted by combining a sensor control unit 209 and a human flow data extraction unit 210 described later.

The edge server 202 includes an original human flow data storage unit 206, an extracted human flow data storage unit 207, a data bus 208, the sensor control unit 209, the human flow data extraction unit 210, a central processing unit (CPU) 211, a memory 212, a communication control unit 213, and a network I/F 214. The sensor control unit 209, the human flow data extraction unit 210, and the communication control unit 213 are implemented by the CPU 211 and the memory 212. The sensor group 201 transmits and receives a control signal of the sensor control unit 209 and acquired data via the network 203, for example. Data transmission and reception via the network 203 in the edge server 202 is implemented by communication control performed by the communication control unit 213 via the data bus 208 and the network I/F 214. Note that transmission and reception of the control signal and the data by the sensor group 201 are not limited to via the network I/F 214, and other interfaces may be used. The acquired original human flow data is stored in the original human flow data storage unit 206 via the network I/F 214 and the data bus 208. The original human flow data stored in the stored original human flow data storage unit 206 is subjected to extraction processing by the human flow data extraction unit 210, and is stored in the extracted human flow data storage unit 207 as extracted human flow data to be transmitted to the cloud server 204. The extracted human flow data stored in the extracted human flow data storage unit 207 is transmitted to the network cloud server 204.

The cloud server 204 includes a tenant attribute DB 215, a trained model DB 216, an extracted human flow data DB 217, a touring data DB 218, a touring data extraction unit 219, a training input data generation unit 220, a model training unit 221, a simulation unit 222, a CPU 223, a memory 224, a communication control unit 225, a network I/F 226, and a data bus 227. The touring data extraction unit 219, the training input data generation unit 220, the model training unit 221, and the simulation unit 222 are implemented by the CPU 223 and the memory 224. Data transmission and reception via the network 203 in the cloud server 204 is implemented by communication control performed by the communication control unit 225 via the data bus 227 and the network I/F 226. The extracted human flow data transmitted from the edge server 202 is stored in the extracted human flow data DB 217. The extracted human flow data stored in the extracted human flow data DB 217 is extracted as the touring data by the touring data extraction unit 219 and stored in the touring data DB 218. The touring data stored in the touring data DB 218 and the tenant attribute stored in the tenant attribute DB 215 are converted into training input data by the training input data generation unit 220, and a trained model is generated as a training result in the model training unit 221 based on the input and stored in the trained model DB 216.

The administrator terminal 205 includes a simulation condition input unit 228, a screen output unit 229, a user interface processing unit 230, a CPU 231, a memory 232, a communication control unit 233, a network I/F 234, and a data bus 235. The user interface processing unit 230 is implemented by the CPU 231 and the memory 232. In the administrator terminal 205, data transmission and reception via the network 203 is implemented by communication control performed by the communication control unit 233 via the data bus 235 and the network I/F 234. A simulation condition for performing a store tenant combination simulation by the mall administrator 302 for increasing touring is input via the simulation condition input unit 228. The screen output unit 229 displays the simulation condition and a simulation result via a user interface processed by the user interface processing unit 230.

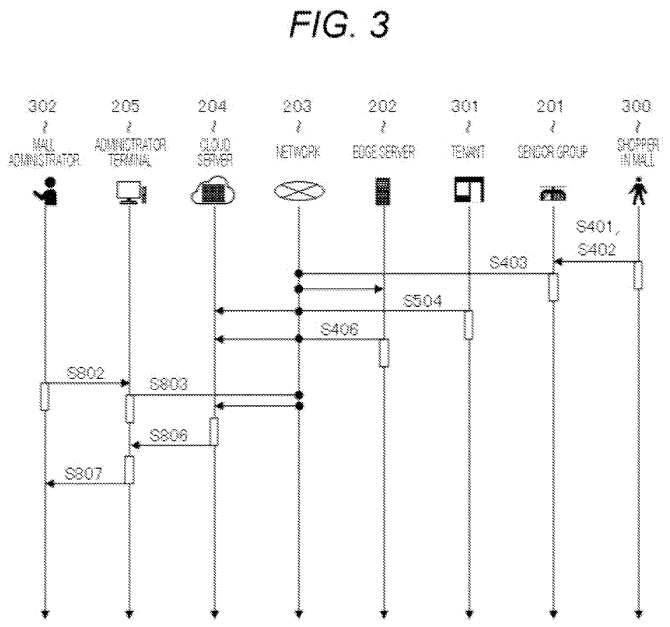

A series of processings in the store tenant combination simulation for increasing touring in the present embodiment will be described with reference to FIGS. 3, 4, 5, 6, 7, 8, and 9.

FIG. 3 is a sequence diagram illustrating a data flow in the present embodiment. FIG. 3 illustrates the data flow among the shopper 300 in the mall, the sensor group 201, a tenant 301, the edge server 202, the network 203, the cloud server 204, the administrator terminal 205, and the mall administrator 302. Details of the steps in the drawing will be described later.

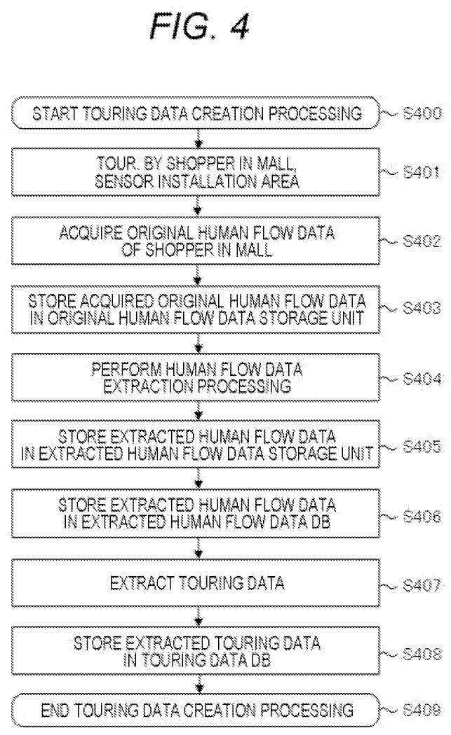

FIG. 4 is a flowchart illustrating touring data creation processing in the present embodiment. Once the touring data creation processing starts (step S400), the shopper 300 in the mall tours stores in a sensor installation area (step S401). In step S402, the sensor group 201 controlled by the sensor control unit 209 acquires, as original human flow data, the touring of the stores by the shopper 300 in the mall in step S401 (step S402). The acquired original human flow data is stored in the original human flow data storage unit 206 via the data bus 208 and the network I/F 214 (step S403). In subsequent step S404, before transmitting the original human flow data stored in the original human flow data storage unit 206 to the cloud server 204, the human flow data extraction unit 210 performs human flow data extraction processing of extracting only data necessary for touring data to be described later, reducing a data size, and further performing format conversion. After step S404, the processing proceeds to step S405.

In step S405, the extracted human flow data obtained by the extraction processing in step S404 is stored in the extracted human flow data storage unit 207. Note that the human flow data extraction processing (step S404) and the storage in the extracted human flow data storage unit 207 (step S405) are not necessarily performed, and may be omitted if touring data extraction processing in the touring data extraction unit 219 described later can be performed with the original human flow data. Further, in the touring data extraction processing according to the present embodiment, it is assumed that the human flow data extraction processing is performed as batch processing after the original human flow data corresponding to a predetermined period or data volume is accumulated in the original human flow data storage unit 206, but timings of the human flow data extraction processing (step S404) and the storage in the extracted human flow data storage unit 207 (step S405) are not necessarily limited to the batch processing, and the human flow data extraction processing (step S404) and the storage in the extracted human flow data storage unit 206 (step S405) may be sequentially performed after the original human flow data acquisition processing (step S402) and the storage in the original human flow data storage unit (step S403). After step S405 is performed, in a case where the extracted human flow data corresponding to a predetermined period or data volume is stored in the extracted human flow data storage unit 207, the processing proceeds to step S406.

In step S406, the extracted human flow data stored in the extracted human flow data storage unit 207 is stored in the extracted human flow data DB 217 via the data bus 208, the network I/F 214, the network 203, the network I/F 226, and the data bus 227. After the extracted human flow data corresponding to the predetermined period or data volume is accumulated in the extracted human flow data DB 217 in step S406, the processing proceeds to step S407 as the batch processing. In step S407, the store touring data is extracted by the processing in the touring data extraction unit 219 based on the extracted human flow data stored in the extracted human flow data DB 217. A timing of the touring data extraction processing is not necessarily limited to the batch processing, and the touring data extraction processing may be sequentially performed after the storage in the extracted human flow data DB 217 (step S406). After step S407, the extracted touring data is stored in the touring data DB 218 (step S408). Once the touring data is stored in the touring data DB 218, the touring data creation processing is completed (step S409). Note that the store touring data used in the present embodiment is not limited to actual data acquired by the sensor group 201, and for example, data created by connecting so-called point of sales (PoS) data in settlement at a cash register of each store in chronological order may be used.

FIG. 5 is a flowchart illustrating tenant attribute creation processing. Once the tenant attribute creation processing starts (step S500), the mall administrator 302 sends, to a plurality of tenants 301 that have opened a store in an area where the optimization system 200 is to be introduced or are scheduled to open a store, an electronic questionnaire related to a tenant attribute which is a parameter group for classifying the tenants (step S501). Note that an electronic questionnaire transmission source is not limited to the mall administrator 302, and may be an agent authorized by the mall administrator 302 or a company that handles the tenant attribute. In subsequent step S502, the tenant 301 having received the electronic questionnaire answers the tenant attribute questionnaire, whereby the tenant attribute is input, and the processing proceeds to step S503. In step S503, the tenant attribute questionnaire answered by the tenant 301 is uploaded. The uploaded tenant attribute is stored in the tenant attribute DB 215 via the network 203, the network I/F 226, and the data bus 227 (step S504). Once the tenant attribute is stored in the tenant attribute DB 215, the tenant attribute creation processing is completed (step S505).

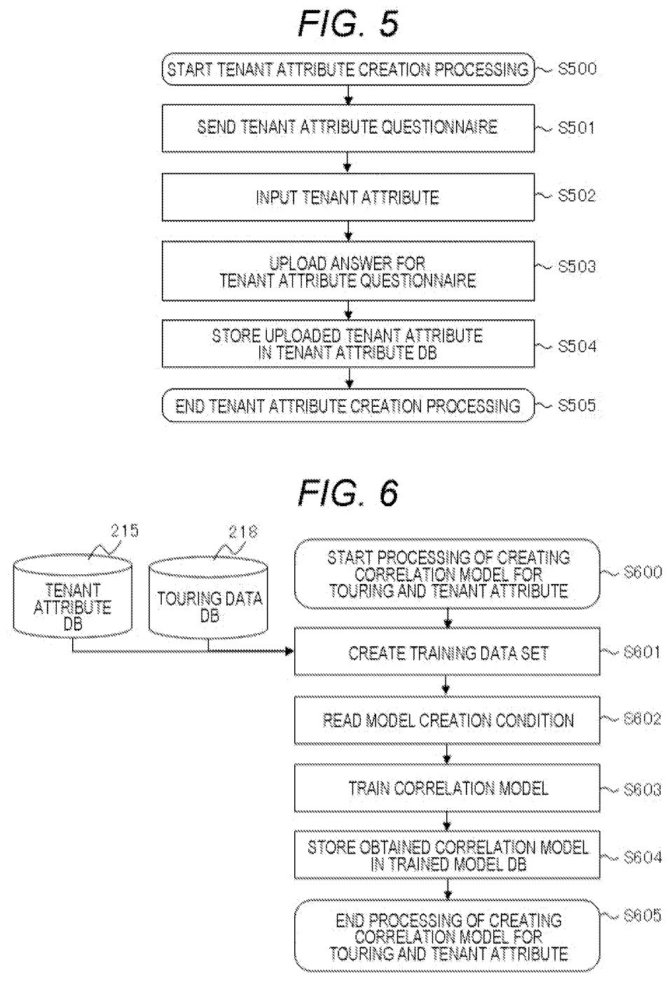

FIG. 6 is a flowchart illustrating processing of creating a correlation model for the touring and the tenant attribute in the present embodiment. Once the processing of creating the correlation model for the touring and the tenant attribute starts (step S600), in step S601, the training input data generation unit 220 creates a training data set by conversion and processing for facilitating analysis based on inputs from the tenant attribute DB 215 and the touring data DB 218. In subsequent step S602, after a model creation condition is read, the processing proceeds to step S603. Here, the model creation condition represents a constraint condition at the time of creating the correlation model, a calculation convergence condition, and the like, and is described in a header file read in advance at the time of model training.

In step S603, correlation model training is performed by the model training unit 221 using the training data set as an input. The correlation model training performed by the model training unit 221 creates a model by applying statistical analysis processing using a neural network such as multivariate analysis such as regression analysis or machine learning to a combination of the touring data input as the training data set and the tenant attribute similarly input as the training data set. In addition, when learning of a correlation of the touring data and the tenant attribute is performed, the model training unit 221 may perform weighting by inputting a factor that facilitates the touring as a weighting parameter. Here, the weighting parameter is, for example, a distance from a touring source and a store area size. In this case, for example, it is sufficient if a weight for the touring data in a case where the distance from the touring source is long is larger than that in a case where the distance from the touring source is short. In addition, it is sufficient if the weight for the touring data in a case where the store area size is small is larger than that in a case where the store area size is large. A regression equation of a touring rate Y of a permanent tenant, which is an objective variable obtained as a result of the correlation analysis, is expressed as Equation 1 by using a plurality of qualitative explanatory variables X_1, . . . , X_n for n tenant attributes, partial regression coefficients b_1, . . . , b_n corresponding to the respective tenant attributes, and bias b_0, for example, in a case of using Quantification I. Once the correlation model training ends, the processing proceeds to subsequent step S604. In step S604, the obtained correlation model is stored in the trained model DB 216. Once the correlation model is stored in the trained model DB 216, the processing of creating the correlation model for the touring and the tenant attribute is completed (step S605).

$$Y = {\sum }_{i = 1}^{n} {b}_{i} {X}_{i} + {b}_{0} \qquad [ Equation 1 ]$$

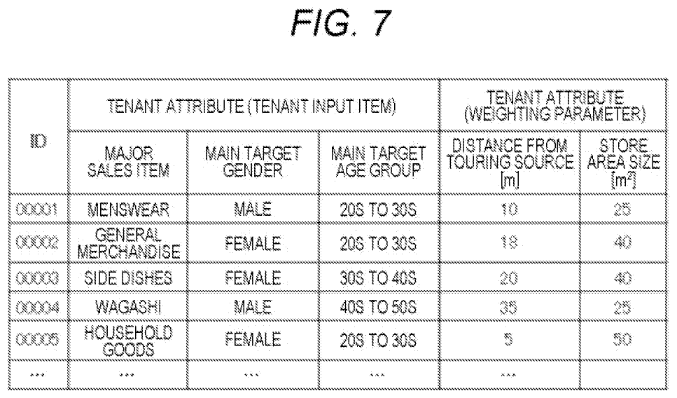

FIG. 7 illustrates an example of the tenant attribute DB 215. In the tenant attribute DB, data is stored for each ID associated with each tenant. A tenant input item which is a parameter obtained from the answer of the tenant 301 for the electronic questionnaire and the weighting parameter which is a parameter for weighting the touring data during the correlation model training performed by the model training unit 221 are stored as the stored tenant attribute. Examples of the tenant input item include a major sales item, a main target gender, a main target age group, and the like, but is not limited thereto, and data may be added as necessary. Examples of the weighting parameter include the distance from the touring source, the store area size, and the like, but is not limited thereto, and data may be added as necessary. In FIG. 7, for example, for a tenant associated with ID 00001, menswear is input as the major sales item, male is input as the main target gender, 20s to 30s is input as the main target age group, 10 m is input as the distance from the touring source, and 25 m² is input as the store area size.

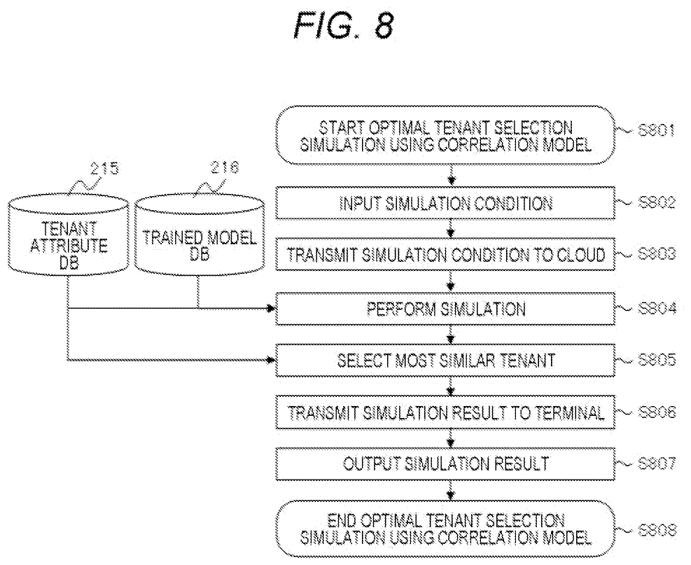

Details of optimal tenant selection simulation in the present embodiment will be described with reference to FIGS. 8, 9, and 10.

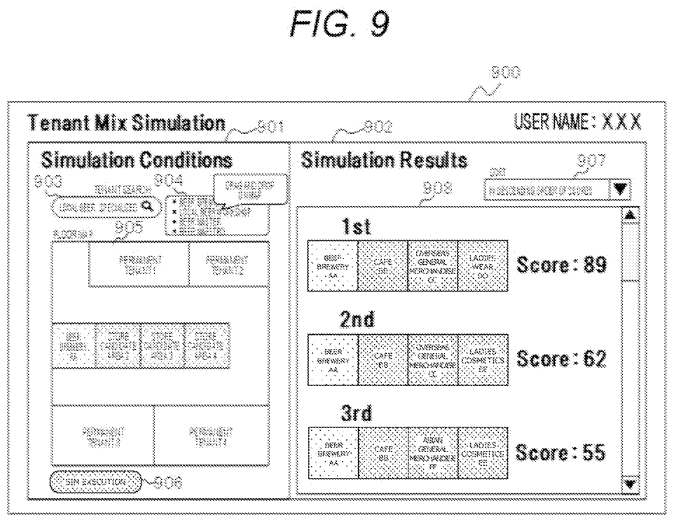

FIG. 9 illustrates an example of a user interface 900 in the optimal tenant selection simulation used by the mall administrator 302 via the administrator terminal 205. Note that the user interface 900 is a system that operates on the web by the processing in the user interface processing unit 230, but may also be implemented by a desktop application. The user interface 900 includes a simulation condition input unit 901 and a simulation result display section 902. The simulation condition input unit 901 includes a tenant search window 903, a tenant candidate list 904, a map display section 905, and a simulation execution button 906.

The tenant search window 903 extracts a highly relevant tenant based on a search word input to the tenant search window 903 by the mall administrator 302 and information registered in the tenant attribute DB 215 by the search function of the simulation unit 222, and displays the extracted tenant in the tenant candidate list 904. The mall administrator 302 sets a simulation condition based on tenant candidates displayed in the tenant candidate list 904. That is, among the candidates displayed in the tenant candidate list 904, a tenant to be exhibited as a fixed tenant by oneself is dragged and dropped on the map display section 905 to be set as a store tenant.

In FIG. 9, as an example, as a result of inputting words “local beer” and “specialized” in the tenant search window 903, “beer brewery AA” is dragged and dropped from the extracted tenant candidate list 904 to a new store area 1 as a fixed tenant and set as the fixed tenant. After the setting of the simulation condition is completed, the optimal tenant selection simulation is executed by pressing the simulation execution button 906. The simulation result display section 902 includes a sorting window 907 and a sorting result display section 908. Once the optimal tenant simulation is performed, the result is displayed on the simulation result display section 902. In the sorting window 907, it is possible to designate a sorting condition as to in which order the simulation results are displayed. Here, the sorting condition is, for example, a descending order of scores and an ascending order of scores. For example, only the top ten combinations of the sorting results are displayed on the sorting result display section 908. FIG. 9 illustrates, as an example, the sorting results in descending order of scores. The top three results are displayed on the sorting result display section 908 on the screen, but it is also possible to display the top ten combinations by scrolling with the scroll bar. Note that the number of combinations that can be displayed is not limited to the top ten, and may be any value. In addition, what is displayed as a result of the display optimal tenant selection simulation is not limited to a tenant name, and may be information regarding the tenant attribute. Note that one tenant may have a plurality of pieces of store attribute information, and accordingly, pieces of information regarding the plurality of tenant attributes may be displayed as a group as the simulation result.

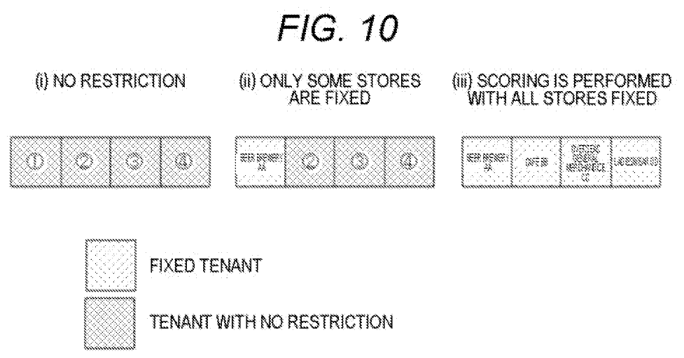

FIG. 8 is a flowchart illustrating the optimal tenant selection simulation using the correlation model. Once the optimal tenant selection simulation using the correlation model starts (step S801), the simulation condition is input by the mall administrator 302 via the administrator terminal 205 (step S802). Here, as described above, the simulation condition is set by dragging and dropping, to the map display section 905, a newly opened tenant as a fixed tenant from the tenant candidate list 904 extracted based on the word input in the tenant search window 903. Here, in a case where the number of stores is fixed, assumed simulation conditions can be roughly classified into three types illustrated in FIG. 10. That is, (i) there is no restriction, (ii) only some stores are fixed, and (iii) scoring is performed with all stores fixed. Among these three types, the mall administrator 302 sets a desired simulation condition, and step S802 ends.

In subsequent step S803, the simulation condition set by the web-based user interface 900 is transmitted to the simulation unit 222 of the cloud server 204 via the data bus 235, the network I/F 234, the network 203, the network I/F 226, and the data bus 227.

In step S804, the simulation in the simulation unit 222 is performed based on the input condition. For example, a tenant attribute X that is a qualitative explanatory variable of a fixed tenant input based on the simulation condition is acquired in association with the trained model stored in the trained model DB 216 from the tenant attribute DB 215, and is input to Equation 1 that is the regression equation of the touring rate Y as the objective variable, whereby a touring rate Y_j of the j-th fixed tenant among all the N_fix fixed tenants is obtained as in Equation 2. Meanwhile, for the remaining (N_c−N_fix) areas among the total N_c new store areas, a combination of the tenant attribute X that is the qualitative explanatory variable with the maximum Y is searched based on Equation 1 that is the regression equation of the touring rate Y as the objective variable.

$${Y}_{j} = {\sum }_{i = 1}^{{N}_{p}} {b}_{ij} {X}_{ij} + {b}_{0} \qquad [ Equation 2 ]$$

As a result, as a score result of the optimal tenant selection simulation, an output with the maximum value is represented by Equation 3. Here, an operator max(A,B) in Equation 3 indicates an operation result of a multivariable expression A in a variable combination in which a calculation result of A is the B-th largest value among variable combinations in which the calculation result of A has the maximum values. As a combination to be displayed by sorting other than the maximum value, the top ten combinations in the score implemented by changing the variable condition in { } in Equation 3 are used. In addition, γ represents a coefficient for converting the objective variable Y in the trained model into a value to be displayed on a simulator. On the other hand, a combination of the minimum values of the score is implemented by converting the operator max into an operator min(A,B) representing a variable combination in which a calculation result of the multivariable expression A is the B-th smallest value among variable combinations in which the calculation result of A has the minimum values. As a combination to be displayed by sorting other than the minimum value, the lower ten combinations in the score similarly implemented by changing the variable condition in { } are used.

$$SCORE = \qquad [ Equation 3 ]$$

$$\frac{γ}{{N}_{c}} [ {\sum }_{j = 1}^{{N}_{fix}} {Y}_{j} + \{ max ( Y , 1 ) + max ( Y , 2 ) + … + max ( Y , {N}_{c} - {N}_{fix} ) \} ] .$$

In subsequent step S805, a tenant group that is most similar to the tenant attribute combination obtained in step S804 is extracted from the existing tenant attribute combinations of the tenants by a most similar tenant group extraction function of the simulation unit 222 with reference to the tenant attribute DB 215. Further, the score is recalculated with the tenant attribute of the extracted most similar tenant group. In a case where the value of the score is changed as a result of the recalculation of the score, the sorting order is also corrected according to the recalculated score. The processing proceeds to step S806. Thereafter, in step S806, as the simulation result, the most similar tenant group combination obtained in step S805 and the score thereof are transmitted to the administrator terminal 205 via the data bus 227, the network I/F 226, the network 203, the network I/F 234, and the data bus 235. Subsequently, the simulation result is drawn on the simulation result display section 902 through the processing in the user interface processing unit 230 and displayed on the screen output unit 229 (step S807). Once the result of the optimal tenant selection simulation using the correlation model is output to the screen output unit 229, the optimal tenant selection simulation using the correlation model is completed. Note that, although the simulation in the simulation unit 222 has been described on the assumption that Quantification I is used in the model training unit 221, in a case where the model training unit 221 uses another analysis method, it is assumed that an optimal tenant simulation result is obtained by a method according to the analysis method. In addition, in the extraction of the most similar tenant group, the tenant attribute may be not only data uploaded in the physical world 100, but also data uploaded in the past as acquired data in another place and stored in the tenant attribute DB 215. Note that the number of target tenants of the optimization performed by the optimization system 200 is not necessarily plural, and the optimization performed by the optimization system 200 may be optimization of a single store.

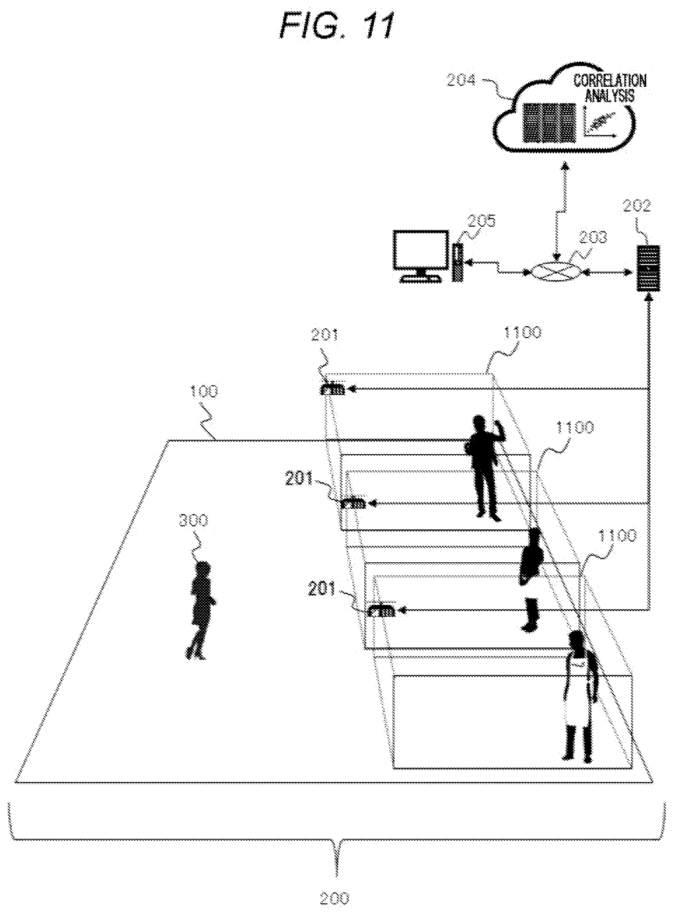

In the present embodiment, a target tenant of store tenant combination optimization has been expressed as a tenant that opens a store in a fixed section of a shopping mall, but the target tenant is not limited to a tenant that opens a store in a fixed section of a shopping mall. For example, as illustrated in FIG. 11, the tenant may be a pop-up store type tenant implemented by installing portable furniture 1100 in an open space without a partition in the physical world 100 unlike a tenant in the so-called fixed section. If the sensor group 201 is installed on the portable furniture 1100, the above-described optimization system 200 and the optimization system 200 using the portable furniture 1100 can be treated as not being different.

According to the above-described configuration and operation described in the present embodiment, the optimization system 200 can implement a continuous increase in touring by store tenant combination optimization.

### Second Embodiment

An embodiment of the present invention will be described with reference to the accompanying drawings. The present embodiment is an embodiment for describing an optimization system for a store tenant combination for continuously increasing touring of permanent tenants in real estate such as a shopping mall. Hereinafter, a description of functions overlapping with those of the first embodiment will be omitted.

A target tenant of store tenant combination optimization in the present embodiment is not a tenant that is to open a permanent store but a pop-up store type tenant that opens a store only for a short period of time.

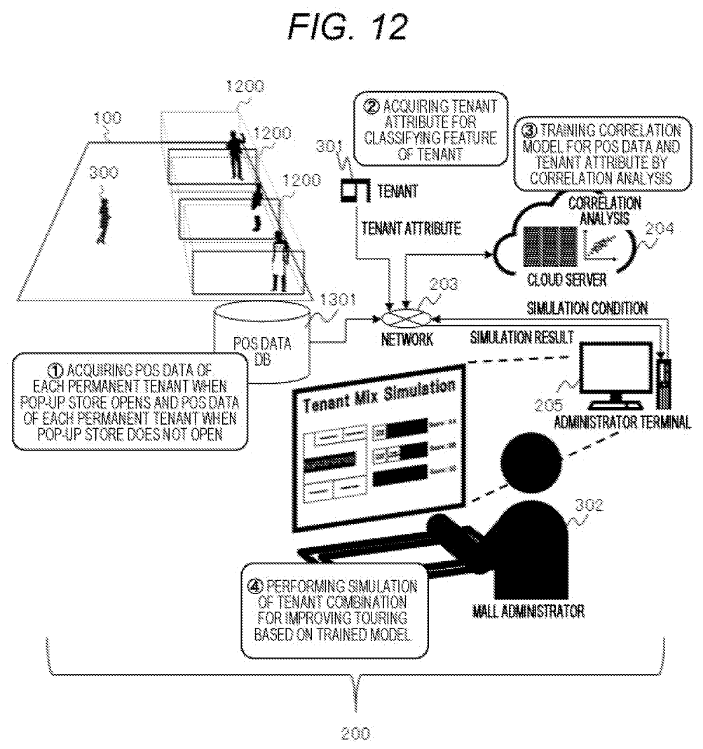

FIG. 12 is a schematic diagram illustrating an overall image of an optimization system 200 for a store tenant combination according to the present embodiment. The optimization system 200 in the present embodiment roughly has four characteristics. The first characteristic is that POS data of each permanent tenant when a pop-up store 1200 opens and POS data of each permanent tenant when the pop-up store 1200 does not open are acquired. The second characteristic is that a tenant attribute for classifying a feature of a tenant is acquired. The third characteristic is that a correlation model for the POS data and a tenant attribute is trained by correlation analysis. The correlation model to be used in a simulation to be described later is created by training using the POS data and the tenant attribute as inputs. The last fourth characteristic is that a tenant combination for increasing sales is simulated based on the trained model.

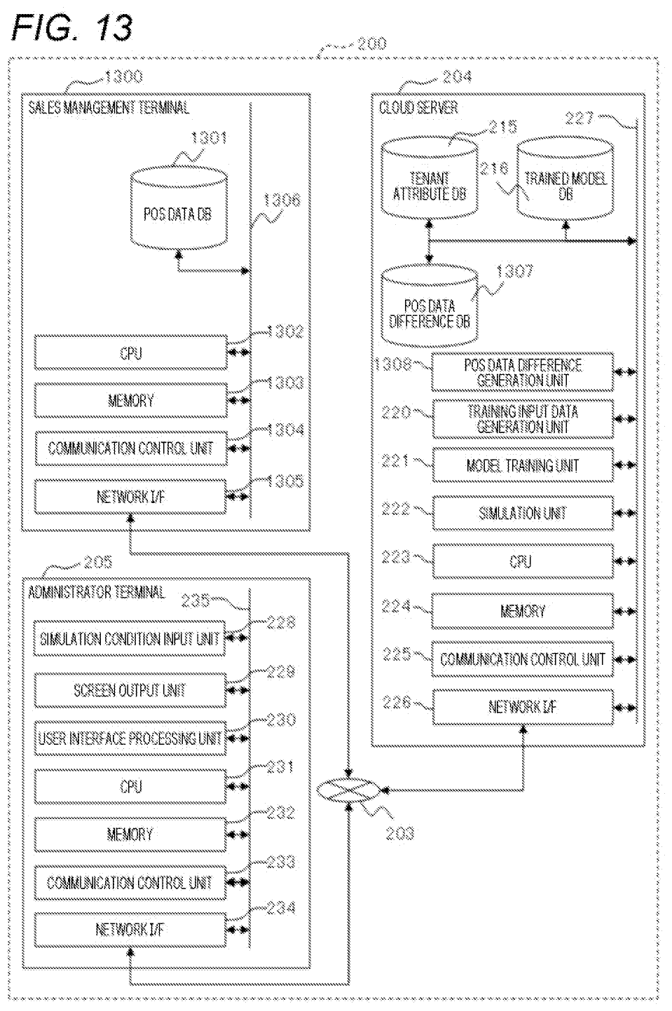

FIG. 13 is a functional block diagram of the optimization system 200 for a store tenant combination according to the present embodiment. The optimization system 200 for a store tenant combination includes a sales management terminal 1300, a network 203, a cloud server 204, and an administrator terminal 205.

The sales management terminal 1300 includes a POS data DB 1301, a CPU 1302, a memory 1303, a communication control unit 1304, a network I/F 1305, and a data bus 1306. In the sales management terminal 1300, data transmission and reception via the network 203 is implemented by communication control performed by the communication control unit 1304 via the data bus 1306 and the network I/F 1305. The POS data when the pop-up store 1200 opens and the POS data when the pop-up store 1200 does not open are stored in the POS data DB 1301.

The functional blocks included in the cloud server 204 are different from those of the first embodiment in that the functional blocks related to the human flow data and touring data processing are not included, and a POS data difference DB 1307 and a POS data difference generation unit 1308 are included.

The functional blocks included in the administrator terminal 205 are the same as those in the first embodiment.

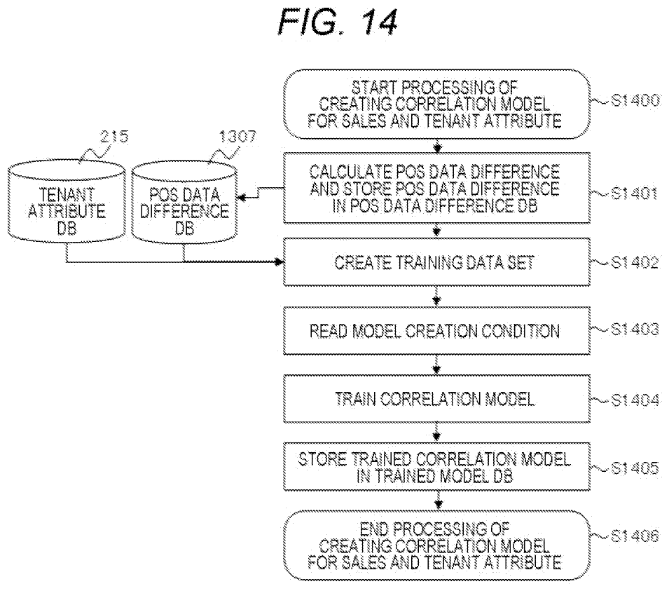

FIG. 14 is a flowchart illustrating processing of creating a correlation model for the sales and the tenant attribute in the present embodiment. Once the processing of creating the correlation model for the sales and the tenant attribute starts (step S1400), in step S1401, the POS data is transmitted from the POS data DB 1301 of the sales management terminal 1300 to the cloud server 204 via the network 203. The POS data difference generation unit 1308 in the cloud server 204 calculates a difference between the POS data when the pop-up store 1200 opens and the POS data when the pop-up store 1200 does not open based on the received POS data to generate a POS data difference, and stores the POS data difference in the POS data difference DB 1307. In subsequent step S1402, a training input data generation unit 220 creates a training data set by conversion and processing for facilitating analysis based on inputs from a tenant attribute DB 215 and the POS data difference DB 1307. In step S1403, after a model creation condition is read, the processing proceeds to step S1404. Here, the model creation condition represents a constraint condition at the time of creating the correlation model, a calculation convergence condition, and the like, and is described in a header file read in advance at the time of model training. In step S1404, correlation model training is performed by a model training unit 221 using the training data set as an input. The correlation model training performed by the model training unit 221 creates a model by applying statistical analysis processing using a neural network such as multivariate analysis such as regression analysis or machine learning to a combination of the POS data difference input as the training data set and the tenant attribute similarly input as the training data set. A regression equation of the POS data difference Y, which is an objective variable obtained as a result of the correlation analysis, is expressed as Equation 1 by using a plurality of qualitative explanatory variables X_1, . . . , X_n for n tenant attributes, partial regression coefficients b_1, . . . , b_n corresponding to the respective tenant attributes, and bias b_0, for example, in a case of using Quantification I. That is, the regression equation is expressed by the same equation as that in the first embodiment only with a difference in input for training. Once the correlation model training ends, the processing proceeds to subsequent step S1405. In step S1405, the obtained correlation model is stored in a trained model DB 216. Once the correlation model is stored in the trained model DB 216, the processing of creating the correlation model for the sales and the tenant attribute is completed (step S1406). Note that, also in the present embodiment, the number of target tenants of the optimization performed by the optimization system 200 is not necessarily plural, and the optimization performed by the optimization system 200 may be optimization of a single store.

A flow of optimal tenant selection simulation using the correlation model in the present embodiment is the same as that in the first embodiment except that the objective variable Y is changed from the touring rate to the sales, and thus, a description thereof is omitted.

### REFERENCE SIGNS LIST

100 physical world
200 optimization system
201 sensor group
202 edge server
203 network
204 cloud server
205 administrator terminal
206 original human flow data storage unit
207 extracted human flow data storage unit
208 data bus
209 sensor control unit
210 human flow data extraction unit
211 CPU
212 memory
213 communication control unit
214 network I/F
215 tenant attribute DB
216 trained model DB
217 extracted human flow data DB
218 touring data DB
219 touring data extraction unit
220 training input data generation unit
221 model training unit
222 simulation unit
223 CPU
224 memory
225 communication control unit
226 network I/F
227 data bus
228 simulation condition input unit
229 screen output unit
230 user interface processing unit
231 CPU
232 memory
233 communication control unit
234 network I/F
300 shopper in mall
301 tenant
302 mall administrator
900 user interface
901 simulation condition input unit
902 simulation result display section
903 tenant search window
904 tenant candidate list
905 map display section
906 simulation execution button
907 sorting window
908 sorting result display section
1100 portable furniture
1200 pop-up store
1300 sales management terminal
1301 POS data DB
1302 CPU
1303 memory
1304 communication control unit
1305 network I/F
1306 data bus
1307 POS data difference DB
1308 POS data difference generation unit

1. An optimization system comprising:
a customer touring acquisition unit that is configured to be able to acquire touring of stores by a customer;
a store attribute information acquisition unit that is configured to be able to acquire one or more items of store attribute information for classifying features of the stores;
a model training unit that creates a correlation model for the touring by the customer and the store attribute information by using the touring of the stores by the customer and the store attribute information as inputs;
a trained model storage unit that stores the created model; and
an output unit that presents information regarding one or more stores to be opened in such a way as to increase the touring of the stores by the customer based on the model.

2. The optimization system according to claim 1, wherein the output unit presents an optimal combination of the stores to be opened in such a way as to increase the touring of the stores by the customer in a specific store.

3. The optimization system according to claim 1, wherein the information regarding the stores to be opened presented by the output unit is a store name or store attribute information.

4. The optimization system according to claim 1, wherein information acquired by the customer touring acquisition unit is store touring information acquired by analyzing data acquired using a sensor or an imaging device.

5. The optimization system according to claim 1, wherein the customer touring acquisition unit acquires point of sales (PoS) data of each of the stores by connecting the PoS data in chronological order.

6. The optimization system according to claim 1, wherein the store to be opened is a unit in which a space is partitioned by furniture.

7. The optimization system according to claim 1, wherein the model training unit performs modeling after weighting the store attribute information that facilitates the touring of the stores by the customer.

8. The optimization system according to claim 7, wherein
the store attribute information includes information regarding a distance from a store touring source and/or a store area size, and
the model training unit creates the correlation model for the touring by the customer and the store attribute information by using the information regarding the distance from the store touring source and/or the store area size as a weighting parameter.

9. An optimization system comprising:
a sales data acquisition unit that is configured to be able to acquire sales data of a permanent store when a store opens and sales data of the permanent store when the store does not open;
a sales data difference acquisition unit that is configured to be able to acquire a difference between sales data of the permanent store when a store that opens only for a limited period of time opens and sales data of the permanent store when the store does not open, based on the data of the sales data acquisition unit;
a store attribute information acquisition unit that is configured to be able to acquire one or more items of store attribute information for classifying feature of the store;
a model training unit that creates a correlation model for a sales data difference and the store attribute information by using the sales data difference and the store attribute information as inputs; and
a trained model storage unit that stores the created model,
wherein information regarding one or more store tenants is presented in such a way as to increase a sales difference based on the model.

10. The optimization system according to claim 1, wherein the model training unit performs training by regression analysis using Quantification I.

11. The optimization system according to claim 1, wherein the model training unit performs training by statistical processing using machine learning.

12. An optimization method for a store combination for presenting an optimal combination of stores to be opened, the optimization method comprising:
a first step of acquiring touring of stores by a customer;
a second step of acquiring one or more items of store attribute information for classifying features of the stores;
a third step of creating a correlation model for the touring by the customer and the store attribute information by using the touring of the stores by the customer and the store attribute information as inputs; and
a fourth step of presenting information regarding one or more stores to be opened in such a way as to increase the touring of the stores by the customer based on the model.

13. An optimization method for a store combination for presenting an optimal combination of stores to be opened, the optimization method comprising:
a first step of acquiring sales data of a permanent store when a store to be opened opens and sales data of the permanent store when the store to be opened does not open;
a second step of acquiring one or more items of store attribute information for classifying features of the stores;
a third step of creating a correlation model for a sales data difference between sales data of the permanent store when a store that opens only for a limited period of time
opens and sales data of the permanent store when the store does not open, and the store attribute information by using the sales data difference and the store attribute information as inputs; and
a fourth step of presenting information regarding one or more stores to be opened in such a way as to increase a sales difference based on the model.

14. The optimization method according to claim 12 or 13, wherein the information regarding the stores to be opened presented in the fourth step is a store name or store attribute information.

15. The optimization system according to claim 2, wherein information acquired by the customer touring acquisition unit is store touring information acquired by analyzing data acquired using a sensor or an imaging device.

16. The optimization system according to claim 3, wherein information acquired by the customer touring acquisition unit is store touring information acquired by analyzing data acquired using a sensor or an imaging device.

17. The optimization system according to claim 9, wherein the model training unit performs training by regression analysis using Quantification I.

18. The optimization system according to claim 9, wherein the model training unit performs training by statistical processing using machine learning.

19. The optimization method according to claim 13, wherein the information regarding the stores to be opened presented in the fourth step is a store name or store attribute information.
